(19) United States
(12) Patent Application Publication
(10) Pub. No.: US 2007/0297166 A1
(43) Pub. Date: Dec. 27, 2007

(54) Electric candle

(76) Inventor: Su-Hua Chen, Taipei County (TW)

Correspondence Address: BACON & THOMAS, PLLC, 625 SLATERS LANE, FOURTH FLOOR, ALEXANDRIA, VA, 22314, US

(21) Appl. No.: 11/472,362

(22) Filed: Jun. 22, 2006

(51) Int. Cl. F21V 35/00

(52) U.S. Cl. 362/161

(57) ABSTRACT

An electric candle is disclosed that includes a housing; a cap secured to a top edge of the housing; a bulb projected from a top of the cap; and a base secured to a bottom edge of the housing and including a battery power source, and a switch. The housing is formed by wrapping a thin piece (e.g., one formed of plastics or paper) and securing both sides of the pieces together by glue or adhesive tape. The candle may be shaped as cylinder or truncated cone. Moreover, a decorative member (e.g., one formed of plastics, paper, or cloth) may be formed around the candle. In addition, a wax drop shaped member may be formed around an upper portion of the decorative member and on a top of the cap.

### BACKGROUND OF THE INVENTION

1. Field of Invention

The present invention relates to electric candles and more particularly to such an electric candle with improved characteristics.

2. Related Art

Conventionally, a candle is employed to give light when burned. However, burning candle suffered from several disadvantages. For example, it may cause fire if sufficient care is not taken. Further, toxic gas may be emitted. Furthermore, it may easily extinguish when wind is blowing.

A variety of electric candles are commercially available for addressing the above problems. One such electric candle has a bulb as a replacement of the typical wick. However, such prior electric candles are typically costly to manufacture due to complicated manufacturing processes, trouble-prone, and unreliable in use. Thus, the need for improvement still exists.

### SUMMARY OF THE INVENTION

It is therefore an object of the present invention to provide an electric candle comprising a housing; a cap secured to a top edge of the housing; a bulb projected from a top of the cap; and a base secured to a bottom edge of the housing and including a battery power source electrically connected to the bulb, and a switch electrically connected to the battery power source.

In one aspect of the present invention the housing is formed by wrapping a thin piece and securing both sides of the pieces together.

In another aspect of the present invention the piece is formed of plastics or paper.

In yet another aspect of the present invention an assembly of the cap, the housing, and the base has a shape of cylinder or truncated cone.

In a further aspect of the present invention there is further provided a decorative member formed around the cap, the housing, and the base, and the decorative member is formed of plastics, paper, or cloth.

In yet further aspect of the present invention there is further provided a wax drop shaped member formed around an upper portion of the decorative member and on a top of the cap.

The above and other objects, features and advantages of the present invention will become apparent from the following detailed description taken with the accompanying drawings.

### BRIEF DESCRIPTION OF THE DRAWINGS

FIG. 1 is a perspective view of a first preferred embodiment of electric candle according to the invention;

FIG. 2 is an exploded view of the electric candle in FIG. 1;

FIG. 3 is an exploded perspective view of a second preferred embodiment of electric candle according to the invention;

FIG. 4 is a perspective view of the assembled electric candle in FIG. 3;

FIG. 5 is a perspective view of a third preferred embodiment of electric candle according to the invention; and

FIG. 6 is a perspective view of a fourth preferred embodiment of electric candle according to the invention.

### DETAILED DESCRIPTION OF THE INVENTION

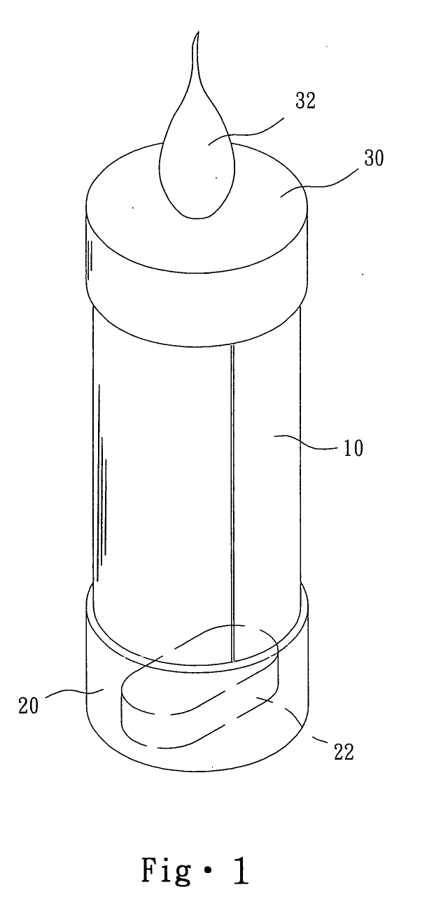

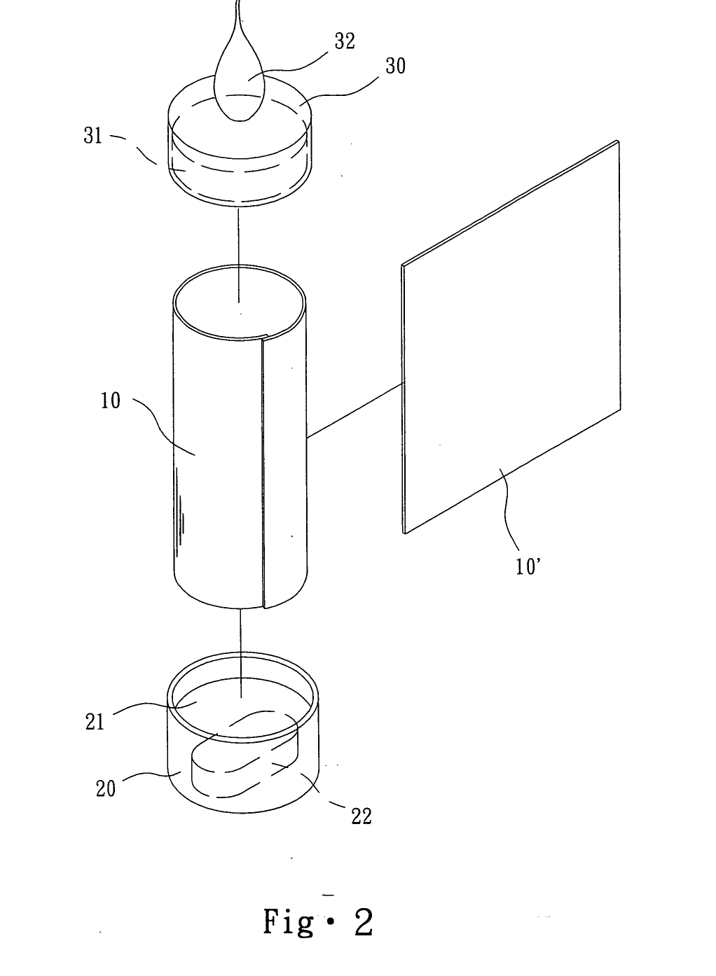

Referring to FIGS. 1 and 2, an electric candle in accordance with a first preferred embodiment of the invention comprises a cylindrical housing 10 formed by wrapping a rectangular thin piece 10′ and securing both sides of the pieces 10′ together by glue or adhesive tape wherein the piece 10′ is formed of plastics, paper, or the like; a cap 30 including an inverted cylindrical first cup 31 and a teardrop shaped bulb 32 projected from a top of the first cup 31; and a base 20 including a cylindrical second cup 21, a battery 22 in the second cup 21, two conductors (not shown) electrically interconnecting the battery 22 and the bulb 32, and an on/off switch (not shown) on an outer surface or bottom of the second cup 21 and electrically connected to the conductors. The circumferential bottom of the housing 10 is inserted into the second cup 21 for fastening and the circumferential top thereof is inserted into the first cup 31 for fastening respectively. In operation, simply slide the switch to on and the bulb 32 then gives light.

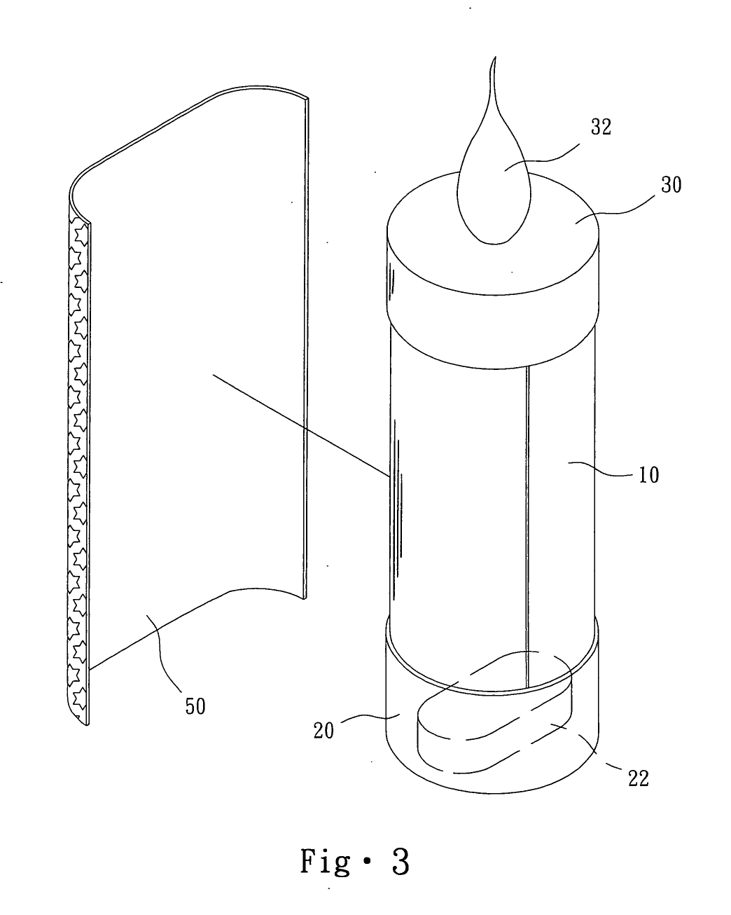

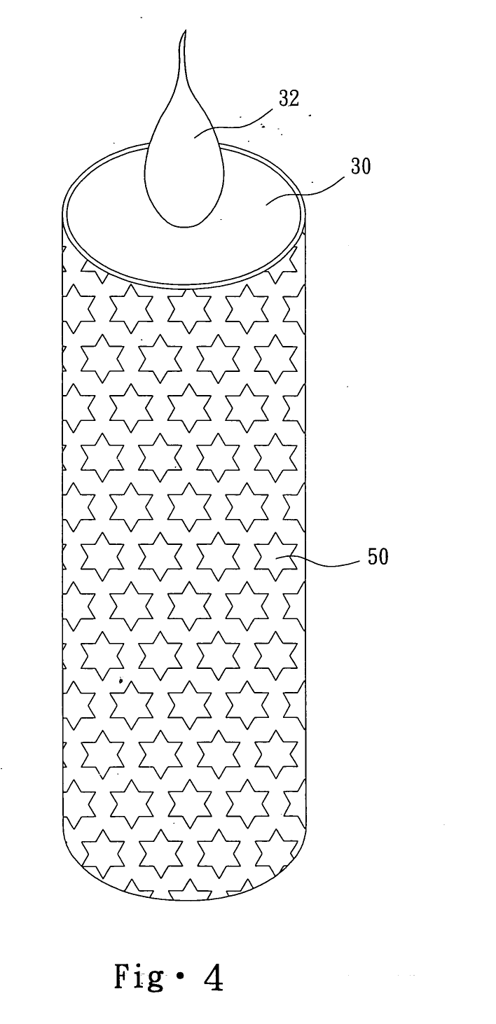

Referring to FIGS. 3 and 4, an electric candle in accordance with a second preferred embodiment of the invention is shown. The second preferred embodiment substantially has same structure as the first preferred embodiment. The characteristics of the second preferred embodiment are detailed below. A rectangular thin decorative member 50 formed of plastics, paper, cloth, or the like is provided. An aesthetic pattern is printed on an outer surface of the decorative member 50. The decorative member 50 is wrapped around the cylindrical portion of assembled electric candle shown in FIG. 1 (i.e., excluding the bulb 32) and its both sides are secured together by glue or adhesive tape. As an end, an electric candle having a cylindrical body is formed.

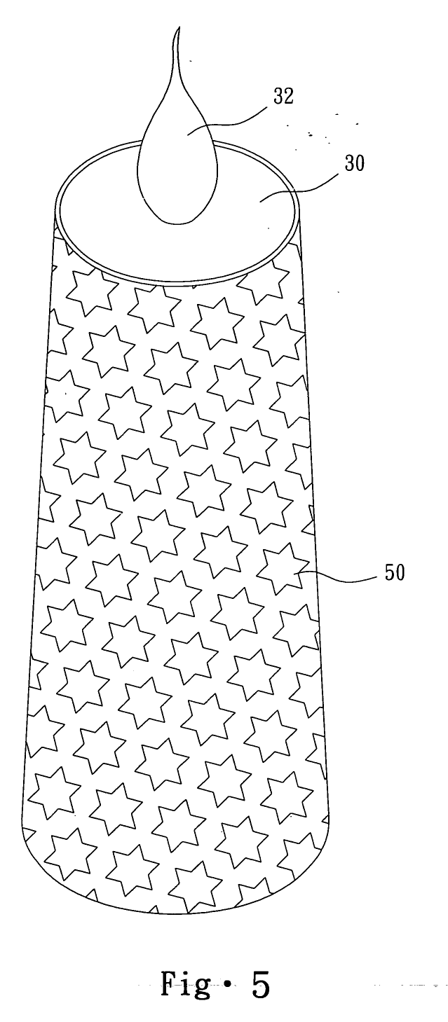

Referring to FIG. 5, an electric candle in accordance with a third preferred embodiment of the invention is shown. The third preferred embodiment substantially has same structure as the second preferred embodiment, except that both the formed electric candle (i.e., an assembly of the cap 30, the housing 10, and the base 20) and the decorative member 50 have a truncated conic body. Note that the formed electric candle may have a shape (e.g., one has a section of triangle) other than above in other embodiments without departing from the scope of the invention.

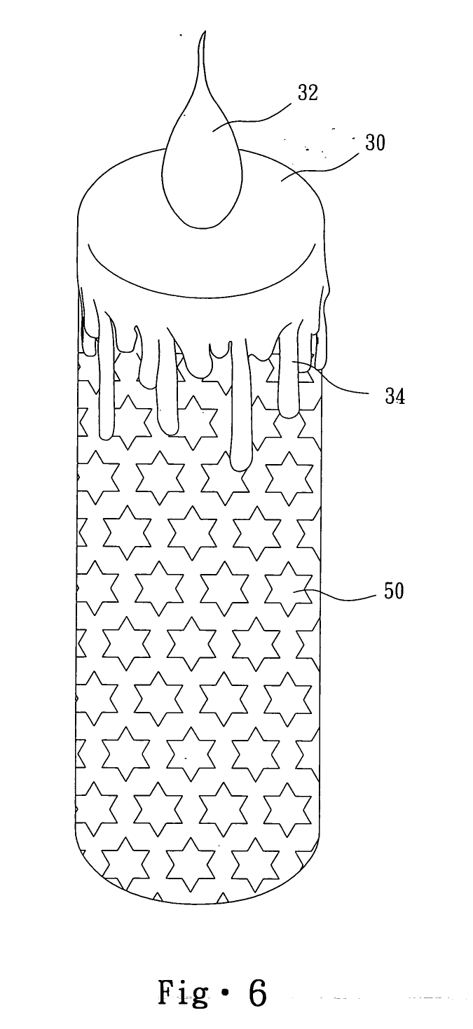

Referring to FIG. 6, an electric candle in accordance with a fourth preferred embodiment of the invention is shown. The fourth preferred embodiment substantially has same structure as the second preferred embodiment, except that a member 34 in imitation of a wax drop when burning is formed around an upper portion of the decorative member 50 and on a top face of the cap 30.

While the invention herein disclosed has been described by means of specific embodiments, numerous modifications and variations could be made thereto by those skilled in the art without departing from the scope and spirit of the invention set forth in the claims.

What is claimed is:

1. An electric candle comprising:
a housing;
a cap secured to a top edge of the housing;
a bulb projected from a top of the cap; and
a base secured to a bottom edge of the housing and including a battery power source electrically connected to the bulb, and a switch electrically connected to the battery power source.

2. The electric candle of claim 1, wherein the housing is formed by wrapping a thin piece and securing both sides of the pieces together.

3. The electric candle of claim 2, wherein the piece is formed of plastics or paper.

4. The electric candle of claim 1, wherein an assembly of the cap, the housing, and the base has a shape of cylinder.

5. The electric candle of claim 1, wherein an assembly of the cap, the housing, and the base has a shape of truncated cone.

6. The electric candle of claim 1, further comprising a decorative member formed around the cap, the housing, and the base.

7. The electric candle of claim 6, wherein the decorative member is formed of plastics, paper, or cloth.

8. The electric candle of claim 6, further comprising a wax drop shaped member formed around an upper portion of the decorative member and on a top of the cap.
